(19) United States
(12) Patent Application Publication
(10) Pub. No.: US 2026/0326462 A1
(43) Pub. Date: Oct. 22, 2026

(54) SHEET CONVEYING DEVICE AND IMAGE FORMING APPARATUS

(71) Applicant: KYOCERA Document Solutions Inc., Osaka (JP)

(72) Inventor: Ryo Egami, Osaka (JP)

(21) Appl. No.: 19/468,316

(22) Filed: Feb. 3, 2026

(30) Foreign Application Priority Data
Feb. 25, 2025 (JP) 2025-028019

(51) Int. Cl. B41J 13/32; B41J 11/00; B41J 13/00

(52) U.S. Cl. CPC B41J 13/32; B41J 11/0095; B41J 13/009

(57) ABSTRACT

A plurality of upstream conveyance paths merges with a main conveyance path. A conveying mechanism conveys a sheet along the plurality of upstream conveyance paths and the main conveyance path. A plurality of correcting mechanisms is disposed in the plurality of respective upstream conveyance paths. The plurality of correcting mechanisms each corrects a sheet orientation including one or both of an inclination angle of the conveyed sheet and an offset of the conveyed sheet in a width direction. An orientation sensing device senses the sheet orientation of the sheet conveyed along the main conveyance path. A control device identifies a target correcting mechanism through which of the plurality of correcting mechanisms a target sheet passes and modifies a correction parameter of the target correcting mechanism depending on a result of sensing of the sheet orientation for the target sheet.

### INCORPORATION BY REFERENCE

This application is based upon and claims the benefit of priority from the corresponding Japanese Patent Application No. 2025-028019 filed on Feb. 25, 2025, the entire contents of which are incorporated herein by reference.

### BACKGROUND

This disclosure relates to a sheet conveying device and an image forming apparatus. The sheet conveying device includes a plurality of correcting mechanisms that corrects the orientation of a sheet in a plurality of conveyance paths.

The image forming apparatus includes the sheet conveying device and a printing device. The printing device forms an image on a sheet conveyed by the sheet conveying device.

It has been known that the sheet conveying device includes an orientation correcting mechanism which corrects the sheet orientation such as the skew of the sheet conveyed toward the printing device.

For example, it has been known that the sheet is conveyed to sandwiching portions of a registration roller pair which is temporarily stopped, thereby correcting the skew of the sheet.

### SUMMARY

A sheet conveying device according to an aspect of this disclosure includes a main conveyance path, a plurality of upstream conveyance paths, a conveying mechanism, a plurality of correcting mechanisms, an orientation sensing device, and a control device. The main conveyance path is a passage of a sheet. Each of the plurality of upstream conveyance paths is the passage of the sheet and merges with the main conveyance path. The conveying mechanism conveys the sheet along the plurality of upstream conveyance paths and the main conveyance path. The plurality of correcting mechanisms is disposed in the plurality of respective upstream conveyance paths. Each of the plurality of correcting mechanisms corrects a sheet orientation including one or both of an inclination angle of the conveyed sheet and an offset of the conveyed sheet in a width direction. The orientation sensing device senses the sheet orientation of the sheet conveyed along the main conveyance path. The control device identifies a target correcting mechanism through which of the plurality of correcting mechanisms a target sheet conveyed along the main conveyance path passes and modifies a correction parameter of the target correcting mechanism depending on a result of sensing of the sheet orientation for the target sheet.

An image forming apparatus according to another aspect of this disclosure includes the sheet conveying device and a printing device that forms an image on a sheet conveyed by the sheet conveying device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment.

FIG. 2 is a block diagram showing a configuration of a control device in the image forming apparatus according to the embodiment.

FIG. 3 is a plan view of configurations of a conveying belt and a line sensor in the image forming apparatus according to the embodiment.

FIG. 4 is a configuration diagram of a correcting mechanism in the image forming apparatus according to the embodiment.

FIG. 5 is a flowchart showing an example of a procedure of orientation correcting control by the image forming apparatus according to the embodiment.

FIG. 6 is a diagram showing an example of a sheet outer shape image extracted from a readout image through an orientation sensing process by the image forming apparatus according to the embodiment of this disclosure.

FIG. 7 is a flowchart showing an example of a procedure of orientation correcting control by an image forming apparatus according to a modification.

### DETAILED DESCRIPTION

Hereinafter, an embodiment of this disclosure will be described with reference to the drawings. It is noted that the following embodiment is a specific example of this disclosure and does not limit the technical scope of this disclosure.

### Configuration of Image Forming Apparatus 10

An image forming apparatus 10 according to the embodiment includes a sheet storing portion 2, a sheet conveying device 3, a printing device 4, and a control device 8. Furthermore, the image forming apparatus 10 also includes a drying device 5, an operation device 801, a display device 802, and the like.

The sheet storing portion 2 stores a sheet 9. The sheet conveying device 3 feeds the sheet 9 from the sheet storing portion 2 and further conveys the sheet 9.

The sheet conveying device 3 includes a main conveyance path 303 that is a conveyance path of the sheet 9. The sheet conveying device 3 conveys the sheet 9 along the main conveyance path 303.

The printing device 4 forms an image on the sheet 9 conveyed by the sheet conveying device 3 along the main conveyance path 303.

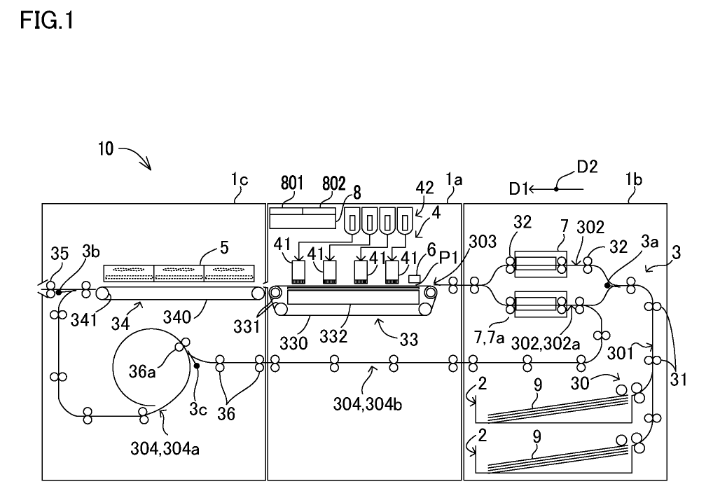

In the example shown in FIG. 1, the printing device 4 executes a print process in an inkjet method.

The printing device 4 includes a plurality of ink heads 41 and a plurality of ink supply portions 42 that correspond to inks of respective different colors. Specifically, the printing device 4 includes the four ink heads 41 and the four ink supply portions 42 corresponding to yellow, magenta, cyan, and black.

The plurality of ink heads 41 each ejects ink to the sheet 9. The plurality of ink supply portions 42 stores inks of the respective different colors and supplies the inks to the plurality of ink heads 41.

In this embodiment, the image forming apparatus 10 also includes the drying device 5. The drying device 5 blows hot air to the sheet 9 on which an image is formed, thereby drying the ink image on the sheet 9.

The operation device 801 senses a human operation. For example, the operation device 801 includes a plurality of operation buttons and a touch panel. The display device 802 is capable of displaying various kinds of information. For example, the display device 802 is a panel display device such as a liquid-crystal display panel.

The control device 8 controls the sheet conveying device 3, the printing device 4, and the drying device 5.

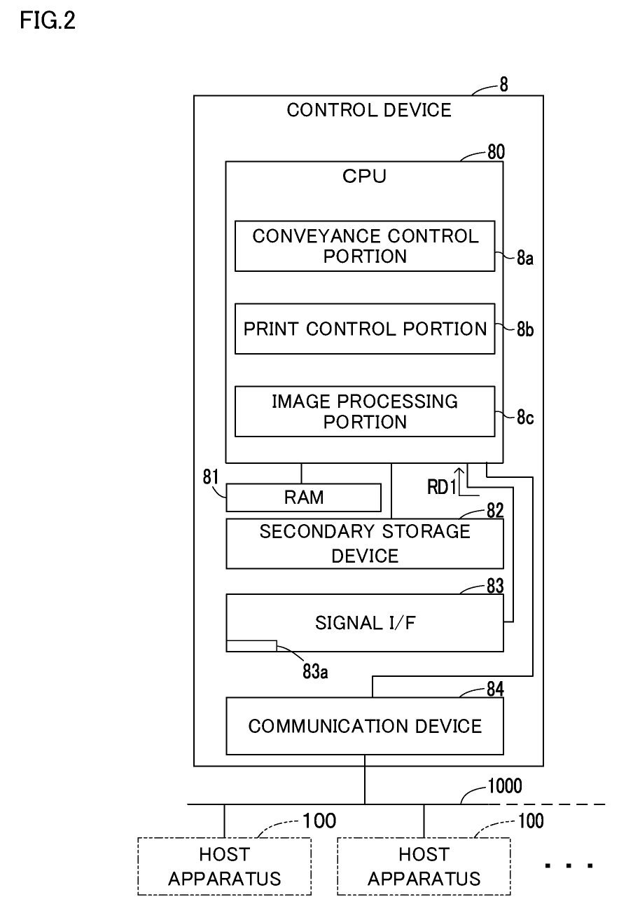

As shown in FIG. 2, the control device 8 includes a central processing unit (CPU) 80, a random access memory (RAM) 81, a secondary storage device 82, a signal interface 83, a communication device 84, and the like.

The CPU 80 executes various kinds of control and data processing by executing computer programs. The RAM 81 temporarily stores the computer programs executed by the CPU 80 and various kinds of data.

The secondary storage device 82 is a computer-readable non-volatile storage device. The secondary storage device 82 stores the computer programs executed by the CPU 80 and the various kinds of data. For example, one of a flash memory or a hard disk drive or both of the flash memory and the hard disk drive are adopted as the secondary storage device 82.

The signal interface 83 converts sense signals of various sensors to digital sense data and transmits the sense data to the CPU 80. Furthermore, the signal interface 83 converts a control instruction output from the CPU 80 to a control signal and transmits the control signal to a control target device.

The communication device 84 executes communication with another apparatus such as a host apparatus 100 through a network 1000. The CPU 80 executes communication with the other apparatus through the communication device 84. The host apparatus 100 is an information processing apparatus that requests the image forming apparatus 10 to execute the print process.

The CPU 80 includes a plurality of processing modules implemented by executing the computer programs. The plurality of processing modules includes a conveyance control portion 8a, a print control portion 8b, and the like (see FIG. 2).

The conveyance control portion 8a controls a plurality of devices in the sheet conveying device 3 to control the conveyance of the sheet 9. In this embodiment, the conveyance control portion 8a is included in a part of the sheet conveying device 3. The conveyance control portion 8a of the CPU 80 is an example of a control device that controls the conveyance of the sheet 9.

The print control portion 8b causes the printing device 4 to execute the print process in synchronization with the conveyance of the sheet 9. Furthermore, the print control portion 8b brings the drying device 5 into operation when the print process is executed.

It is noted that some or all of the processes to be executed by the CPU 80 may be executed by a digital signal processor (DSP), a system on a chip (SoC), or the like. The CPU 80, the DSP, and the SoC are respective examples of a processor.

Incidentally, the sheet conveying device 3 includes a plurality of upstream conveyance paths 302 that merges with the main conveyance path 303 (see FIG. 1). In the example shown in FIG. 1, the sheet conveying device 3 includes the two upstream conveyance paths 302. The sheet conveying device 3 may include the three or more upstream conveyance paths 302.

The following description refers to a direction in which the sheet 9 is conveyed in each of the conveyance paths as a conveyance direction D1 and refers to the direction orthogonal to the conveyance direction D1 as a width direction D2.

Furthermore, the sheet conveying device 3 includes a plurality of correcting mechanisms 7 that is disposed in the plurality of respective upstream conveyance paths 302 and each corrects the sheet orientation of the conveyed sheet 9 (see FIG. 1). In the example shown in FIG. 1, the sheet conveying device 3 includes the two correcting mechanisms 7. The sheet conveying device 3 may include the three or more correcting mechanisms 7.

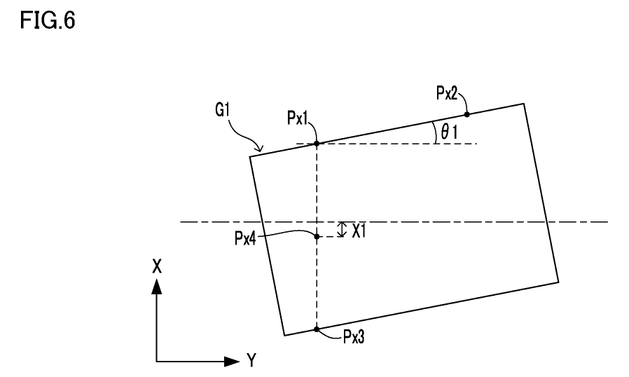

The sheet orientation includes one or both of an inclination angle θ1 of the sheet 9 conveyed along each of the upstream conveyance paths 302 and an offset amount X1 of the sheet 9 in the width direction D2 (see FIG. 6). For example, the inclination angle θ1 is the inclination angle of the sheet 9 relative to the conveyance direction D1.

To increase the output image quality of the image forming apparatus 10, it is desirable to convey the sheet 9 with an appropriate orientation in the main conveyance path 303 even in a case where the sheet 9 is conveyed through any of the plurality of upstream conveyance paths 302.

The sheet conveying device 3 has a configuration in which the sheet 9 is conveyed with an appropriate orientation in the main conveyance path 303 regardless of a conveyance path of the sheet 9.

### Configuration of Sheet Conveying Device 3

The sheet conveying device 3 includes a feeding path 301, the plurality of upstream conveyance paths 302, the main conveyance path 303, and a sub-conveyance path 304 that are respective conveyance paths of the sheet 9 (see FIG. 1).

The feeding path 301 has a source end that communicates with the sheet storing portion 2 and a terminal end that branches into the plurality of upstream conveyance paths 302. The feeding path 301 is a source that branches into the plurality of upstream conveyance paths 302.

The plurality of upstream conveyance paths 302 merges with the main conveyance path 303. The sub-conveyance path 304 branches from a downstream portion of an image formation position in the main conveyance path 303 in the conveyance direction D1 and merges with a specific upstream conveyance path 302a. The specific upstream conveyance path 302a is one of the plurality of upstream conveyance paths 302.

The following description refers to one of the plurality of correcting mechanisms 7 that is disposed in the specific upstream conveyance path 302a as a specific correcting mechanism 7a.

In a case where single-sided printing is executed, the sheet conveying device 3 conveys the sheet 9 along the feeding path 301, any of the plurality of upstream conveyance paths 302, and the main conveyance path 303 and further conveys the sheet 9 out of the main conveyance path 303. The single-sided printing is a process of forming an image on only a single side of the sheet 9.

In a case where double-sided printing is executed, the sheet conveying device 3 conveys the sheet 9 along the feeding path 301, any of the plurality of upstream conveyance paths 302, and the main conveyance path 303. Furthermore, the sheet conveying device 3 conveys the sheet 9 from the main conveyance path 303 to the main conveyance path 303 again through the sub-conveyance path 304 and further conveys the sheet 9 out of the main conveyance path 303. The double-sided printing is a process of forming images on both sides of the sheet 9.

The sheet conveying device 3 includes a feeding mechanism 30, a plurality of feeding roller pairs 31, a plurality of upstream conveying roller pairs 32, a first belt conveying device 33, a second belt conveying device 34, a discharge roller pair 35, and a plurality of sub-conveying roller pairs 36 (see FIG. 1).

Furthermore, the sheet conveying device 3 includes a first path switching mechanism 3a, a second path switching mechanism 3b, and a third path switching mechanism 3c (see FIG. 1).

The feeding mechanism 30 feeds the sheet 9 in the sheet storing portion 2 to the feeding path 301. The plurality of feeding roller pairs 31 conveys the sheet 9 along the feeding path 301 and further conveys the sheet 9 to any of the plurality of upstream conveyance paths 302.

The first path switching mechanism 3a selectively guides the sheet 9 to one of the plurality of upstream conveyance paths 302.

The plurality of upstream conveying roller pairs 32 conveys the sheet 9 in each of the upstream conveyance paths 302. The first belt conveying device 33 and the second belt conveying device 34 each convey the sheet 9 along the main conveyance path 303.

The first belt conveying device 33 takes over the conveyance of the sheet 9 from the plurality of upstream conveying roller pairs 32 and further conveys the sheet 9 to the second belt conveying device 34. The second belt conveying device 34 takes over the conveyance of the sheet 9 from the first belt conveying device 33 and further conveys the sheet 9 to the discharge roller pair 35 or the sub-conveyance path 304.

The first belt conveying device 33 includes an endless conveying belt 330 and a plurality of support rollers 331 that supports the conveying belt 330 such that the conveying belt 330 is rotatable. Furthermore, the first belt conveying device 33 also includes a suction device 332 that causes the sheet 9 to be adsorbed onto the upper surface of the conveying belt 330. The first belt conveying device 33 conveys the sheet 9 adsorbed onto the upper surface of the rotating conveying belt 330.

The second belt conveying device 34 includes an endless conveying belt 340 and a plurality of support rollers 341 that supports the conveying belt 340 such that the conveying belt 340 is rotatable. The second belt conveying device 34 conveys the sheet 9 placed on the upper surface of the rotating conveying belt 340.

The sheet conveying device 3 also includes an unillustrated belt driving motor that rotates one of the plurality of support rollers 331 and one of the plurality of support rollers 341.

The plurality of upstream conveying roller pairs 32, the first belt conveying device 33, and the second belt conveying device 34 are examples of a conveying mechanism that conveys the sheet 9 along the plurality of upstream conveyance paths 302 and the main conveyance path 303.

The discharge roller pair 35 conveys the sheet 9 to a downstream portion out of the main conveyance path 303. The downstream portion is a sheet tray or a post-processing device that executes a post-process on the sheet 9. The post-process is a perforation process of making a punch hole in the sheet 9, a staple process of binding the sheets 9, a sheet folding process of folding the sheet 9, or the like.

The second path switching mechanism 3b selectively guides the sheet 9 passing through the second belt conveying device 34 to one of the discharge roller pair 35 and the sub-conveyance path 304.

The plurality of sub-conveying roller pairs 36 conveys the sheet 9 along the sub-conveyance path 304 and further conveys the sheet 9 from the sub-conveyance path 304 to the main conveyance path 303.

The sub-conveyance path 304 includes a first sub-conveyance path 304a and a second sub-conveyance path 304b. The first sub-conveyance path 304a branches from the main conveyance path 303. The second sub-conveyance path 304b branches from the first sub-conveyance path 304a and merges with the specific upstream conveyance path 302a. The second sub-conveyance path 304b merges with an upstream portion of the specific correcting mechanism 7a in the specific upstream conveyance path 302a in the conveyance direction D1.

In this embodiment, the feeding path 301 and the sub-conveyance path 304 are examples of a plurality of further upstream conveyance paths that is supply paths of the sheet 9 for the specific upstream conveyance path 302a. It is noted that the sheet conveying device 3 may include the three or more further upstream conveyance paths. For example, the plurality of further upstream conveyance paths includes a manual feed sheet conveyance path extending from an unillustrated manual feed tray to the specific upstream conveyance path 302a in some cases.

The plurality of sub-conveying roller pairs 36 includes an inverting roller pair 36a disposed near a portion of the first sub-conveyance path 304a that branches into the second sub-conveyance path 304b.

The inverting roller pair 36a rotates in a first rotation direction to convey the sheet 9 toward the terminal end of the first sub-conveyance path 304a. Furthermore, the inverting roller pair 36a rotates in a second rotation direction to invert and convey the sheet 9 from the first sub-conveyance path 304a to the second sub-conveyance path 304b. This conveys the sheet 9 to the second sub-conveyance path 304b with the inverted front and back and top and bottom.

The third path switching mechanism 3c guides the sheet 9 toward the terminal of the first sub-conveyance path 304a when the inverting roller pair 36a rotates in the first rotation direction. Furthermore, the third path switching mechanism 3c guides the sheet 9 from the first sub-conveyance path 304a to the second sub-conveyance path 304b when the inverting roller pair 36a rotates in the second rotation direction.

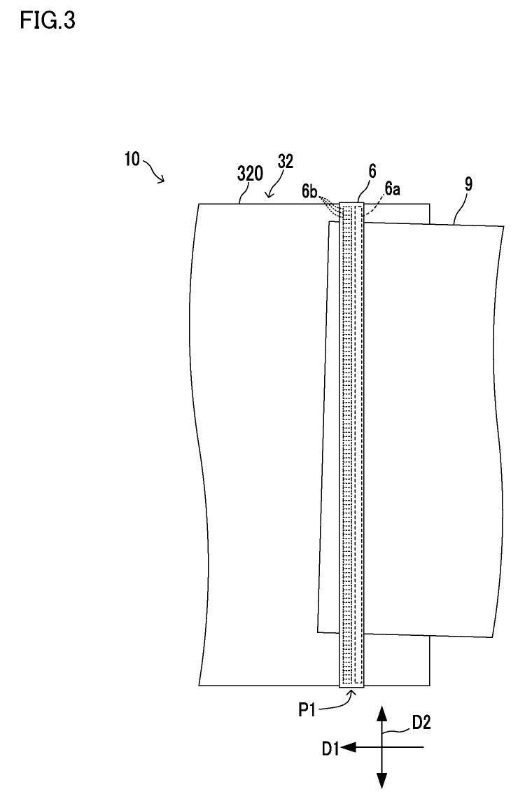

The sheet conveying device 3 further includes a line sensor 6 (see FIGS. 1 and 3). The line sensor 6 is disposed to be opposed to a sensing position P1 on the upper surface of a conveying belt 330 in the first belt conveying device 33 (see FIG. 1). The line sensor 6 is disposed along the width direction D2 (see FIG. 3).

The sensing position P1 is an upstream position of the image formation position in the main conveyance path 303 in the conveyance direction D1. The line sensor 6 is an image sensor that reads an image of the region at the sensing position P1 along the width direction D2.

The line sensor 6 includes a light emitting portion 6a and a plurality of photoelectric conversion elements 6b (see FIG. 3). The plurality of photoelectric conversion elements 6b is arranged along the width direction D2. The light emitting portion 6a emits light to the sensing position P1 on the surface of the conveying belt 330.

The plurality of photoelectric conversion elements 6b each senses the amount of diffused reflection light on the surface of the conveying belt 330 and outputs a plurality of pixel signals each indicating the amount of sensed light. The signal interface 83 includes an analog front end (AFE) 83a that converts the plurality of pixel signals sequentially output by the line sensor 6 to a plurality of pieces of pixel data (see FIG. 2).

The plurality of pieces of pixel data for a plurality of lines output from the AFE 83a is transmitted to the CPU 80 as readout image data RD1 (see FIG. 2). When the sheet 9 is passing through the sensing position P1, the line sensor 6 comes into operation, thereby offering the readout image data RD1.

The plurality of processing modules in the CPU 80 includes an image processing portion 8c that processes the readout image data RD1 (see FIG. 2). The image processing portion 8c executes an orientation sensing process of sensing the sheet orientation.

For example, in the orientation sensing process, the image processing portion 8c extracts a sheet outer shape image G1 from the image of the readout image data RD1 through an edge detection process on the readout image data RD1 (see FIG. 6). The sheet outer shape image G1 shows the outer shape of the sheet 9. In the readout image data RD1, an X coordinate indicates a position in the width direction D2 and a Y coordinate indicates a position in the conveyance direction D1.

Furthermore, in the orientation sensing process, the image processing portion 8c senses the inclination angle θ1 of the sheet 9 and the offset amount X1 of the sheet 9 in the width direction D2 on the basis of the sheet outer shape image G1 (see FIG. 6).

For example, the image processing portion 8c identifies the coordinates of a first side end point Px1 and a second side end point Px2 each of which is one of the end points of the sheet outer shape image G1 in the X-axial direction at a first Y coordinate and a second Y coordinate (see FIG. 6).

Furthermore, in the orientation sensing process, the image processing portion 8c derives the angle formed by the straight line passing through the first side end point Px1 and the second side end point Px2 relative to the Y-axial direction as the inclination angle θ1.

Furthermore, in the orientation sensing process, the image processing portion 8c identifies the coordinates of the first side end point Px1 and a third side end point Px3 that are both end points of the sheet outer shape image G1 in the X-axial direction at the first Y coordinate (see FIG. 6).

Furthermore, in the orientation sensing process, the image processing portion 8c derives the difference between the X coordinate of a midpoint Px4 between the first side end point Px1 and the third side end point Px3 and a reference coordinate defined in advance as the offset amount X1.

It is noted that the image processing portion 8c may identify the coordinates of a first front end point and a second front end point that are end points of the sheet outer shape image G1 in the Y-axial direction. The end points of the sheet outer shape image G1 are located at two positions having an interval in between in the X-axial direction. In this case, the image processing portion 8c derives the angle formed by the straight line passing through the first front end point and the second front end point relative to the X-axial direction as the inclination angle θ1.

In this embodiment, the line sensor 6, the AFE 83a, and the image processing portion 8c are examples of an orientation sensing device that senses the sheet orientation of the sheet 9 conveyed along the main conveyance path 303. The orientation sensing device senses the sheet orientation of the sheet 9 passing through the sensing position P1 in the main conveyance path 303.

As described below, the correction parameter of any of the plurality of correcting mechanisms 7 is modified depending on results of the sensing of the inclination angle θ1 and the offset amount X1.

In the example shown in FIG. 1, the image forming apparatus 10 is divided into a main unit 1a, an upstream unit 1b, and a downstream unit 1c. The upstream unit 1b and the downstream unit 1c are each connected to the main unit 1a.

The sheet storing portion 2, the feeding path 301, the plurality of upstream conveyance paths 302, the plurality of feeding roller pairs 31, the plurality of upstream conveying roller pairs 32, and the plurality of correcting mechanisms 7 are disposed in the upstream unit 1b.

The first belt conveying device 33 and the printing device 4 are disposed in the main unit 1a. The drying device 5, the second belt conveying device 34, and the discharge roller pair 35 are disposed in the downstream unit 1c.

The sub-conveyance path 304 and the plurality of sub-conveying roller pairs 36 are disposed through the downstream unit 1c, the main unit 1a, and the upstream unit 1b.

### Correcting Mechanism 7

In this embodiment, each of the correcting mechanisms 7 corrects the inclination angle θ1 and the offset amount X1 of the sheet 9 conveyed along each of the upstream conveyance paths 302.

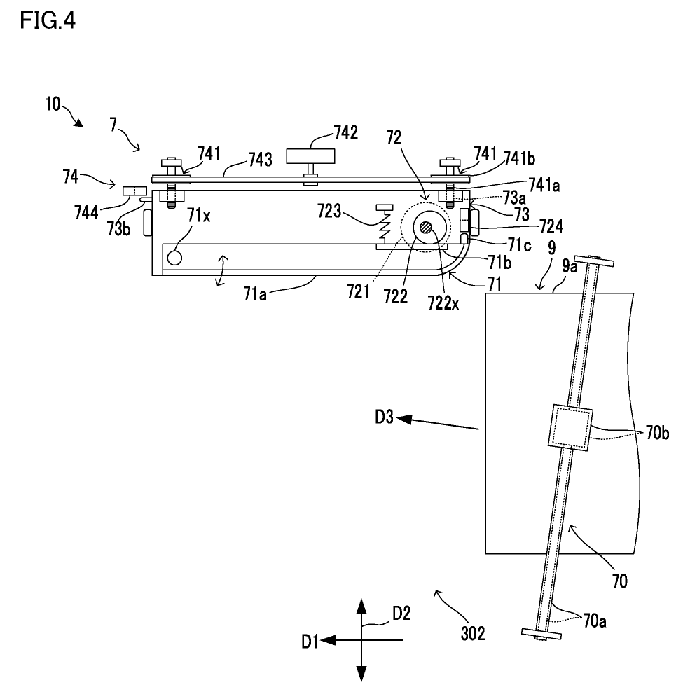

Each of the correcting mechanisms 7 includes an oblique conveying mechanism 70, a correcting member 71, a skew adjusting mechanism 72, a support member 73, and an offset adjustment mechanism 74 (see FIG. 4).

The correcting member 71 has a contact surface 71a that comes into contact with a side end 9a of the sheet 9 at an end of each of the upstream conveyance paths 302 in the width direction D2. The contact surface 71a is a surface that guides the side end 9a of the sheet 9 along the conveyance direction D1.

The oblique conveying mechanism 70 conveys the sheet 9 toward the contact surface 71a along a third direction D3 oblique to the conveyance direction D1.

In the example shown in FIG. 4, the oblique conveying mechanism 70 includes a pair of rotation shafts 70a disposed obliquely to the width direction D2 and a roller pair 70b supported by the pair of rotation shafts 70a.

The correcting member 71 is supported so as to be rotatable about a shaft portion 71x (see FIG. 4). The correcting member 71 rotates to change the angle of the contact surface 71a relative to the conveyance direction D1.

The skew adjusting mechanism 72 comes into operation by receiving a first driving signal and changes the angle of the contact surface 71a relative to the conveyance direction D1. In this embodiment, the skew adjusting mechanism 72 is a mechanism that rotates the correcting member 71 about the shaft portion 71x. The first driving signal is output from the control device 8 to the skew adjusting mechanism 72.

In the example shown in FIG. 4, the skew adjusting mechanism 72 includes a first control motor 721, a cam 722, and a spring 723. Furthermore, the skew adjusting mechanism 72 also includes a first base point sensing sensor 724.

The first control motor 721 rotates in the first rotation direction or the second rotation direction by receiving the first driving signal. For example, the first control motor 721 is a stepping motor, a servo motor, or the like. The first control motor 721 operates in accordance with the first driving signal and pivots the cam 722 about a rotation shaft 722x.

The cam 722 pivots in contact with a contact target portion 71b of the correcting member 71 to swing the correcting member 71 about the shaft portion 71x. The correcting member 71 swings to change the angle of the contact surface 71a relative to the conveyance direction D1.

The spring 723 biases the correcting member 71 toward the cam 722 to keep the cam 722 in contact with the contact target portion 71b of the correcting member 71.

The first base point sensing sensor 724 is supported by the support member 73 and senses a first sensing target portion 71c formed at the correcting member 71. The first base point sensing sensor 724 senses that the contact surface 71a of the correcting member 71 has a reference angle defined in advance relative to the conveyance direction D1.

For example, the first base point sensing sensor 724 is a transmissive photosensor, a reflective photosensor, or the like. The angle of the contact surface 71a is adjusted depending on how much the cam 722 rotates after the first sensing target portion 71c is sensed by the first base point sensing sensor 724.

It is noted that the skew adjusting mechanism 72 may be another mechanism which converts the rotation operation of the output shaft of the first control motor 721 to the swing operation of the correcting member 71.

The support member 73 supports the correcting member 71 and the skew adjusting mechanism 72. The support member 73 is supported so as to be movable along the width direction D2 (see FIG. 4).

The offset adjustment mechanism 74 comes into operation by receiving a second driving signal and changes the position of the contact surface 71a in the width direction D2. In this embodiment, the offset adjustment mechanism 74 is a mechanism that moves the support member 73 in the width direction D2.

In the example shown in FIG. 4, the offset adjustment mechanism 74 includes a plurality of rotors 741 each supported so as to be rotatable, a second control motor 742, and an endless driving belt 743. Each of the rotors 741 includes a screw shaft 741a and a pulley 741b. Furthermore, the offset adjustment mechanism 74 also includes a second base point sensing sensor 744.

The driving belt 743 is bridged over the pulleys 741b of the plurality of rotors 741 and the output shaft of the second control motor 742. The support member 73 has a plurality of screw holes 73a formed therein. The plurality of screw holes 73a is engaged with the screw shafts 741a of the plurality of rotors 741.

The second control motor 742 rotates in the first rotation direction or the second rotation direction by receiving the second driving signal. For example, the second control motor 742 is a stepping motor, a servo motor, or the like. The second control motor 742 rotates in accordance with the second driving signal and rotates the plurality of rotors 741 through the driving belt 743.

The second control motor 742 comes into operation to rotate the plurality of rotors 741 and move the support member 73 along the width direction D2.

The second base point sensing sensor 744 senses a second sensing target portion 73b formed at the support member 73. The second base point sensing sensor 744 senses that the support member 73 is located at a reference position defined in advance.

For example, the second base point sensing sensor 744 is a transmissive photosensor, a reflective photosensor, or the like. The position of the contact surface 71a in the width direction D2 is adjusted depending on how much the second control motor 742 rotates after the second sensing target portion 73b is sensed by the second base point sensing sensor 744.

It is noted that the offset adjustment mechanism 74 may be another mechanism which converts the rotation operation of the output shaft of the second control motor 742 to the linear movement operation of the support member 73.

The position of the support member 73 is changed to change a position at which the contact surface 71a regulates the sheet 9 in the width direction D2.

Each of the correcting mechanisms 7 adjusts the angle of the contact surface 71a of the correcting member 71 to adjust the degree to which the inclination angle θ1 of the sheet 9 is corrected. Furthermore, each of the correcting mechanisms 7 adjusts the position of the support member 73 in the width direction D2 to adjust the degree to which the offset amount X1 of the sheet 9 is corrected.

The following description refers to the adjustment value of the angle of the contact surface 71a in the skew adjusting mechanism 72 as a skew adjustment value. In addition, the adjustment value of the position of the support member 73 in the offset adjustment mechanism 74 will be referred to as an offset adjustment value.

In this embodiment, a plurality of correction parameters is set in association with the plurality of correcting mechanisms 7. The plurality of correction parameters each includes the skew adjustment value and the offset adjustment value. The plurality of correction parameters is stored in the secondary storage device 82.

In each of the plurality of correction parameters, standard values for both the skew adjustment value and the offset adjustment value are set in advance as initial values.

It is noted that each of the correcting mechanisms 7 may be implemented in a configuration different from the configuration shown in FIG. 4. For example, each of the correcting mechanisms 7 may include a turntable mechanism that corrects the skew of the sheet 9 and a slide mechanism that corrects the offset of the sheet 9.

The turntable mechanism holds the sheet 9 and rotates the held sheet 9. The slide mechanism is a mechanism that slides and moves the turntable mechanism in the width direction D2. In this case, the turntable mechanism temporarily stops the conveyance of the sheet 9 and resumes the conveyance of the sheet 9 after the slide mechanism comes into operation.

### Orientation Correcting Process

The conveyance control portion 8a causes the sheet conveying device 3 to convey the sheet 9 in response to a print request. The conveyance control portion 8a and the image processing portion 8c execute an orientation correcting process when the sheet conveying device 3 is conveying the sheet 9.

For example, the conveyance control portion 8a and the image processing portion 8c execute the orientation correcting process in parallel with the print process when the print request is made. For example, the conveyance control portion 8a and the image processing portion 8c execute the orientation correcting process whenever the one sheet 9 or the plurality of sheets 9 is conveyed.

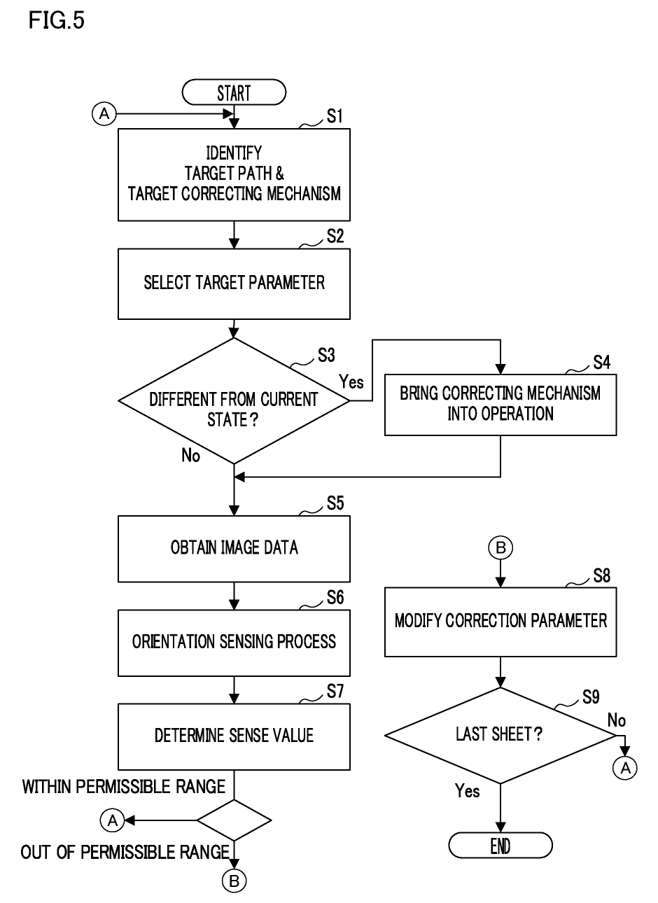

Hereinafter, examples of procedures of the orientation correcting process will be described with reference to the flowchart shown in FIG. 5.

In the following description, S1, S2, ... represent the identification signs of a plurality of steps in the orientation correcting process. In the orientation correcting process, the process of step S1 is first executed.

In addition, the sheet 9 to be conveyed in the main conveyance path 303 will be referred to as a target sheet. The target sheet is the sheet 9 that is a target the sheet orientation of which is to be sensed.

### Step S1

In step S1, the conveyance control portion 8a identifies a target path and a target correcting mechanism corresponding to the target sheet. The target correcting mechanism is one of the plurality of correcting mechanisms 7 through which the target sheet passes.

The target path is a path through which the target sheet passes before reaching the main conveyance path 303. The target path includes at least information for identifying through which of the plurality of upstream conveyance paths 302 the target sheet passes.

Here, the two respective combinations of the specific upstream conveyance path 302a with the feeding path 301 and the sub-conveyance path 304 are referred to as two combination paths. In this embodiment, in a case where the target sheet passes through the specific upstream conveyance path 302a, the target path includes information for identifying through which of the two combination paths the target sheet passes.

That is, in a case where the target correcting mechanism is the specific correcting mechanism 7a, the conveyance control portion 8a identifies through which of the plurality of combination paths the target sheet passes.

Additionally, in a case where the sheet conveying device 3 includes three or more further upstream conveyance paths, the target path is information for identifying through which of the three or more further upstream conveyance paths the target sheet passes.

The conveyance control portion 8a shifts the process to step S2 after executing the process of step S1.

### Step S2

In step S2, the conveyance control portion 8a selects a target parameter corresponding to the target correcting mechanism from the plurality of correction parameters set in advance.

As described above, the plurality of correction parameters each includes the skew adjustment value and the offset adjustment value. In this embodiment, the parameter of the plurality of correction parameters that corresponds to the specific correcting mechanism 7a includes two specific correction parameters corresponding to the two combination paths.

In a case where the specific correcting mechanism 7a is the target correcting mechanism, the conveyance control portion 8a thus selects one of the two specific correction parameters that corresponds to the target path as the target parameter.

The conveyance control portion 8a shifts the process to step S3 after executing the process of step S2.

### Step S3

In step S3, the conveyance control portion 8a selects a next process depending on whether or not the target parameter results in the same adjustment state as the current adjustment state in the target correcting mechanism.

In a case where the target parameter results in a different adjustment state from the current adjustment state in the target correcting mechanism, the conveyance control portion 8a shifts the process to step S4. In contrast, in a case where the target parameter results in the same adjustment state as the current adjustment state in the target correcting mechanism, the conveyance control portion 8a shifts the process to step S5.

### Step S4

In step S4, the conveyance control portion 8a brings the target correcting mechanism into operation such that the target correcting mechanism has an adjustment state compliant with the target parameter.

That is, the conveyance control portion 8a outputs one or both of the first driving signal and the second driving signal corresponding to the target parameter to the target correcting mechanism. This adjusts the target correcting mechanism in accordance with the target parameter.

The conveyance control portion 8a shifts the process to step S5 after executing the process of step S4.

### Step S5

In step S5, the image processing portion 8c obtains the readout image data RD1 when the target sheet passes through the sensing position P1. This readout image data RD1 is image data obtained by the line sensor 6 for the target sheet.

The image processing portion 8c shifts the process to step S6 after executing the process of step S5.

### Step S6

In step S6, the image processing portion 8c executes the orientation sensing process on the readout image data RD1 obtained in step S5. This derives the sense value of the sheet orientation for the target sheet.

In this embodiment, the sense value of the sheet orientation includes the inclination angle θ1 and the offset amount X1 (see FIG. 6). The image processing portion 8c shifts the process to step S7 after executing the process of step S6.

### Step S7

In step S7, the conveyance control portion 8a selects a next process depending on whether or not the sense value of the sheet orientation is within a permissible range set in advance.

In a case where the sense value of the sheet orientation is within the permissible range, the conveyance control portion 8a shifts the process to step S1. This executes the process of step S1 and the subsequent processes on the new target sheet.

In contrast, in a case where the sense value of the sheet orientation is out of the permissible range, the conveyance control portion 8a shifts the process to step S8.

### Step S8

In step S8, the conveyance control portion 8a modifies the target parameter depending on the sense value of the sheet orientation out of the permissible range.

That is, in a case where the sense value of the inclination angle θ1 is out of an angle permissible range, the conveyance control portion 8a modifies the skew adjustment value of the target parameter depending on the sense value of the inclination angle θ1.

Similarly, in a case where the sense value of the offset amount X1 is out of an offset permissible range, the conveyance control portion 8a modifies the offset adjustment value of the target parameter depending on the sense value of the offset amount X1.

Through the process of step S8, the target parameter stored in the secondary storage device 82 is updated.

The conveyance control portion 8a shifts the process to step S9 after executing the process of step S8.

### Step S9

In step S9, the conveyance control portion 8a selects a next process depending on whether or not the target sheet is the last sheet 9 that is conveyed in the print process.

In a case where the target sheet is not the last sheet 9, the conveyance control portion 8a shifts the process to step S1. This executes the process of step S1 and the subsequent processes on the new target sheet.

In contrast, in a case where the target sheet is the last sheet 9, the conveyance control portion 8a brings the orientation correcting control to an end.

As described above, the conveyance control portion 8a identifies the target correcting mechanism of the plurality of correcting mechanisms 7 through which the target sheet conveyed along the main conveyance path 303 passes (see step S1).

Furthermore, the conveyance control portion 8a modifies the target parameter corresponding to the target correcting mechanism depending on a result of the sensing of the sheet orientation for the target sheet (see step S8).

The tendency of the sheet orientation differs for each of the conveyance paths of the sheet 9. The orientation correcting control is executed to make it possible to convey the sheet 9 with an appropriate orientation in the main conveyance path 303 regardless of a conveyance path of the sheet 9.

In addition, in a case where the target correcting mechanism is the specific correcting mechanism 7a, the conveyance control portion 8a identifies through which of the two combination paths the target sheet passes (see step S1).

Furthermore, the conveyance control portion 8a modifies the two specific correction parameters corresponding to the specific correcting mechanism 7a individually for the two respective combination paths (see steps S2 and S8).

The two specific correction parameters are thus set appropriately depending on the tendencies of the sheet orientations in the two respective combination paths.

### Modification

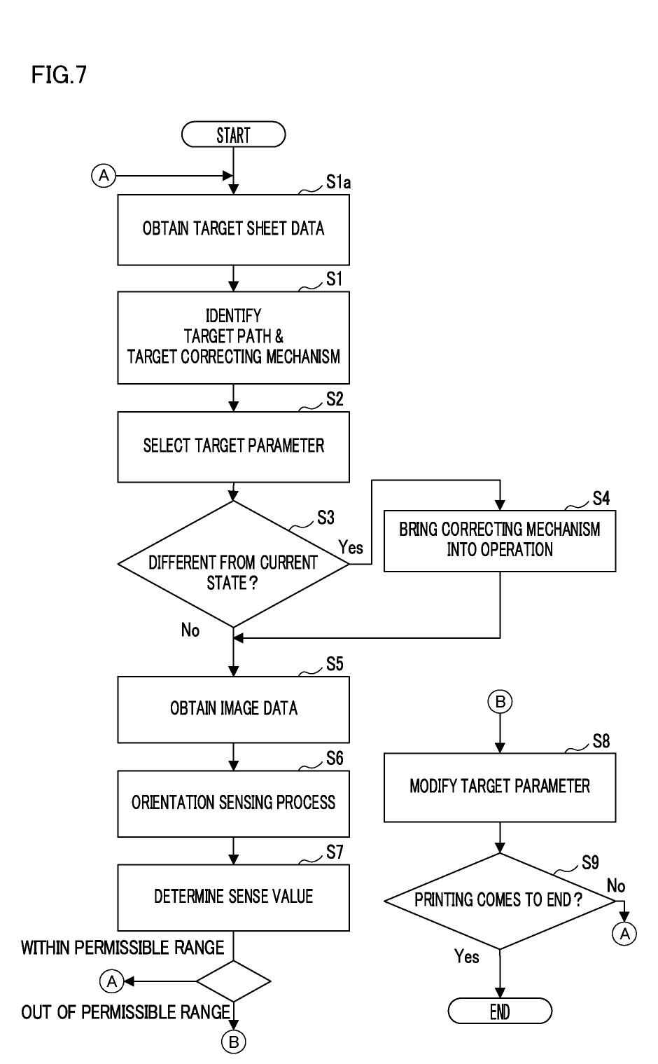

Next, procedures of the orientation correcting control according to a modification of the image forming apparatus 10 will be described with reference to the flowchart shown in FIG. 7. The following description refers to the orientation correcting control according to this modification as a modification control example.

The modification control example is executed in procedures obtained by adding step S1a to the orientation correcting control shown in FIG. 5. Hereinafter, points of the modification control example different from the orientation correcting control shown in FIG. 5 will be described.

In the modification control example, the process of step S1a is first executed.

### Step S1a

In step S1a, the conveyance control portion 8a obtains target sheet data including information about the type of the target sheet. The target sheet data is included in the print request.

For example, the information about the type of the target sheet includes one or more of the thickness, the size, and the basis weight of each of the sheets 9 conveyed in the print process corresponding to the print request.

The conveyance control portion 8a shifts the process to step S1 after executing the process of step S1a.

### Step S1

The process of step S1 in this modification is the same as the process of step S1 shown in FIG. 5. The conveyance control portion 8a shifts the process to step S2 after executing the process of step S1.

### Step S2

In step S2 according to this modification, the conveyance control portion 8a selects the target parameter corresponding to the target correcting mechanism from the plurality of correction parameters.

In this modification, the plurality of correction parameters is set for respective combinations of the plurality of correcting mechanisms 7 and the type of the sheet 9. As described above, the type of the sheet 9 includes one or more of thickness, size, and basis weight.

In this modification, the conveyance control portion 8a selects the target parameter corresponding to the combination of the target correcting mechanism and the type of the target sheet from the plurality of correction parameters.

The conveyance control portion 8a shifts the process to step S3 after executing the process of step S2.

### Steps S3 to S9

The processes of steps S3 to S9 in this modification are the same as the processes of steps S3 to S9 shown in FIG. 5.

However, in a case where the sense value of the sheet orientation is within the permissible range in step S7, the conveyance control portion 8a shifts the process to step S1a. This executes the process of step S1a and the subsequent processes on the new target sheet.

Similarly, in a case where the target sheet is not the last sheet 9 in step S9, the conveyance control portion 8a shifts the process to step S1a. This executes the process of step S1a and the subsequent processes on the new target sheet.

As described above, in this modification, the conveyance control portion 8a obtains the information about the type of the target sheet (see step S1a).

Furthermore, in this modification, the conveyance control portion 8a sets the modification value of the correction parameter of the target correcting mechanism for each type of the target sheet.

In a case where this modification is adopted, an effect similar to the effect obtained in a case where the image forming apparatus 10 is adopted is obtained.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

A sheet conveying device including:
a main conveyance path that is a passage of a sheet;
a plurality of upstream conveyance paths each of which is the passage of the sheet and merges with the main conveyance path;
a conveying mechanism configured to convey the sheet along the plurality of upstream conveyance paths and the main conveyance path;
a plurality of correcting mechanisms that is disposed in the plurality of respective upstream conveyance paths, the plurality of correcting mechanisms being each configured to correct a sheet orientation including one or both of an inclination angle of the conveyed sheet and an offset of the conveyed sheet in a width direction;
an orientation sensing device configured to sense the sheet orientation of the sheet conveyed along the main conveyance path; and
a control device configured to identify a target correcting mechanism through which of the plurality of correcting mechanisms a target sheet conveyed along the main conveyance path passes and modify a correction parameter of the target correcting mechanism depending on a result of sensing of the sheet orientation for the target sheet.

### Supplementary Note 2

The sheet conveying device according to Supplementary Note 1, including a plurality of further upstream conveyance paths each of which is a supply path of the sheet for a specific upstream conveyance path that is one of the plurality of upstream conveyance paths, in which

the plurality of correcting mechanisms includes a specific correcting mechanism disposed in the specific upstream conveyance path,

in a case where the target correcting mechanism is the specific correcting mechanism, the control device identifies through which of a plurality of combination paths the target sheet passes, the plurality of combination paths being respective combinations of the specific upstream conveyance path and the plurality of further upstream conveyance paths, and

the control device further modifies the correction parameter of the specific correcting mechanism individually for each of the plurality of combination paths.

### Supplementary Note 3

The sheet conveying device according to Supplementary Note 2, in which the plurality of further upstream conveyance paths includes a feeding path and a sub-conveyance path, the feeding path being a source that branches into the plurality of upstream conveyance paths, the sub-conveyance path branching from the main conveyance path and merging with the specific upstream conveyance path.

### Supplementary Note 4

The sheet conveying device according to any one of Supplementary Notes 1 to 3, in which the control device obtains information about a type of the sheet and sets a modification value of the correction parameter of the target correcting mechanism for each type of the target sheet.

### Supplementary Note 5

An image forming apparatus including:
the sheet conveying device according to any one of Supplementary Note 1 to 4; and
a printing device configured to form an image on a sheet conveyed by the sheet conveying device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A sheet conveying device comprising:
a main conveyance path that is a passage of a sheet;
a plurality of upstream conveyance paths each of which is the passage of the sheet and merges with the main conveyance path;
a conveying mechanism configured to convey the sheet along the plurality of upstream conveyance paths and the main conveyance path;
a plurality of correcting mechanisms that is disposed in the plurality of respective upstream conveyance paths, the plurality of correcting mechanisms being each configured to correct a sheet orientation including one or both of an inclination angle of the conveyed sheet and an offset of the conveyed sheet in a width direction;
an orientation sensing device configured to sense the sheet orientation of the sheet conveyed along the main conveyance path; and
a control device configured to identify a target correcting mechanism through which of the plurality of correcting mechanisms a target sheet conveyed along the main conveyance path passes and modify a correction parameter of the target correcting mechanism depending on a result of sensing of the sheet orientation for the target sheet.

2. The sheet conveying device according to claim 1, comprising a plurality of further upstream conveyance paths each of which is a supply path of the sheet for a specific upstream conveyance path that is one of the plurality of upstream conveyance paths, wherein
the plurality of correcting mechanisms includes a specific correcting mechanism disposed in the specific upstream conveyance path,
in a case where the target correcting mechanism is the specific correcting mechanism, the control device identifies through which of a plurality of combination paths the target sheet passes, the plurality of combination paths being respective combinations of the specific upstream conveyance path and the plurality of further upstream conveyance paths, and
the control device further modifies the correction parameter of the specific correcting mechanism individually for each of the plurality of combination paths.

3. The sheet conveying device according to claim 2, wherein the plurality of further upstream conveyance paths includes a feeding path and a sub-conveyance path, the feeding path being a source that branches into the plurality of upstream conveyance paths, the sub-conveyance path branching from the main conveyance path and merging with the specific upstream conveyance path.

4. The sheet conveying device according to claim 1, wherein the control device obtains information about a type of the sheet and sets a modification value of the correction parameter of the target correcting mechanism for each type of the target sheet.

5. An image forming apparatus comprising:
the sheet conveying device according to claim 1; and
a printing device configured to form an image on a sheet conveyed by the sheet conveying device.
